(19) United States
(12) Patent Application Publication
(10) Pub. No.: US 2010/0117821 A1
(43) Pub. Date: May 13, 2010

(54) CHILD MONITORING SYSTEM

(76) Inventor: DEBRA J. CRUZ, Rancho Santa Margarita, CA (US)

Correspondence Address: James Ray & Associates, 2640 Pitcairn Road, Monroeville, PA, 15146, US

(21) Appl. No.: 12/616,469

(22) Filed: Nov. 11, 2009

Related U.S. Application Data
(60) Provisional application No. 61/113,864, filed on Nov. 12, 2008.

(51) Int. Cl. G08B 23/00; G08B 1/08

(52) U.S. Cl. 340/539.1; 340/573.4

(57) ABSTRACT

The present invention provides adults with an effective way of keeping track of small children and pets in large areas. Small, portable motion detectors can be set up as a perimeter around a swimming pool or large yard. The child or pet, wearing a sensor, would set off an alarm when they near the motion detectors. This would let the adult know that a breach has occurred.

### CROSS REFERENCE TO RELATED APPLICATION

This patent application is related to and claims priority from U.S. Provisional Patent Application Ser. No. 61/113,864 filed Nov. 12, 2008.

### FIELD OF THE INVENTION

This invention generally pertains to child monitoring systems. More specifically, the present invention relates to a portable battery operated child monitoring system.

### BACKGROUND OF THE INVENTION

The invention is particularly applicable to child and personal monitoring systems and will be described with particular reference thereto. However, it will be appreciated by those skilled in the art that the invention has broader applications and may also be adapted for use as inventory control, lost prevention system and similar systems and devices.

Many accidental drownings occur because small children wander into a yard with an accessible pool. When there are many people present at a gathering, it is difficult to keep track of all the children. Even some animals are unable to swim and are in danger of drowning if not constantly watched. There are also many times that a yard is too large and small children and pets can wander too far away from supervision. Accidents can occur when they are left unattended. Many of the available alarm systems are expensive and are not kid friendly.

One of the primary disadvantages of other child monitoring systems is that they require labor intensive installation. Typically a wire is buried around a perimeter to create a zone that a child is either limited to or limited from. Other child monitoring systems require the installation of a home base unit of some kind. These home base units are typically radio frequency transceivers, that are installed by being hardwired into a home electrical system.

There is currently a need for a child monitoring system that can monitor a child's location in regard to a prohibited zone and can be easy installed and uninstalled as needed.

Accordingly, it has been considered desirable to develop a new and improved child monitoring system which would overcome the foregoing difficulties and others while providing better and more advantageous overall results

### SUMMARY OF THE INVENTION

The present invention provides adults with an effective way of keeping track of small children and pets in large areas. Small, portable motion detectors can be set up as a perimeter around a swimming pool or large yard. The child or pet, wearing a sensor, would set off an alarm when they are near the motion detectors. This would let the adult know that a breach has occurred.

The present invention uses motion sensors to detect when a child or pet has ventured too close to a given point. The motion detectors may be portable and battery operated so they are easy to set up and dismantle. They may be made to sit on concrete, or have an attached stake so they can be placed in the ground. The devices may be made out of plastic so that they are durable and weather-resistant. It may take two to four detectors to set up a perimeter depending on the size of the area being contained. The sensors on the devices may intersect to form the desired perimeter. The motion detectors in several embodiments will actually detect the presence or motion of a sensor. The sensor could be any known in the art, or could be another detectable device such as a tag, electronic tag, radio frequency device, radio frequency identification device, or the like.

The sensors that would be worn by children would come in many different forms. There would be variations in the form of pins, necklaces, bracelets, and hair clips. They may be brightly colored and reflect popular children styles so the child is enthusiastic about wearing the sensor. The pet sensor may be contained as a dog collar charm. These sensors may be designed to set off the motion detectors set around perimeter. An alarm, chime, or music may sound when the sensor approaches a predetermined range from the device. The user may be able to customize their device to their preferences.

The present invention could use technology similar to many types of electronic article surveillance systems, including magnetic, magneto-harmonic, acousto-magnetic, magnetostrictive, radio frequency, microwave or the like systems. One benefit of these technologies is that the sensors or tags can be made very inexpensively and can be made very small. Another benefit is that the sensors or tags are passive devices that do not require their own power source. The combination of these benefits allows for the construction of very small and light sensors that can be incorporated into almost any clothing article. The sensors or tags could comprise an amorphous metal (metglas), a strip of magnetostrictive, ferromagnetic amorphous metal, a strip of a magnetically semi-hard metallic strip, a LC tank circuit, a diode, a microwave antenna and/or an electrostatic antenna. In a preferred embodiment a sensor is constructed into the head of a safety pin.

### OBJECTS OF THE INVENTION

It is, therefore, one of the primary objects of the present invention to provide a wireless child monitoring system.

Another object of the present invention is to provide a portable wireless child monitoring system.

Still another object of the present invention is to provide a child monitoring system that is easy to set up and operate.

In one embodiment the invention is a method for detecting the presence of a child within a predetermined area comprising the steps of: providing a tag detector, attaching to said child a tag responsive to the electromagnetic radiation generated by said tag detector; said tag receiving said electromagnetic radiation; said tag detector receiving said electromagnetic radiation; and sounding an alarm on said tag detector in response to application of said electromagnetic radiation. In another embodiment said tag detector is a magnetic type tag detector. In yet another embodiment said tag detector is an acousto-magnetic type tag detector. In still another embodiment said tag detector is a radio frequency type tag detector. In yet still another embodiment said tag detector is a microwave type tag detector.

In another embodiment the invention is a system for detecting the presence of a child within a predetermined area comprising: at least two battery powered tag detectors, at least one tag affixed to a child, wherein at least one of the at least two battery powered tag detectors sounds an alarm when said at least one tag comes within a predetermined distance from said at least one of the at least two battery powered tag detectors. In yet another embodiment said at least two battery powered tag detectors comprise: at least one stake for affixing to a surface, and a speaker for audibly sounding said alarm. In still another embodiment said at least two battery powered tag detectors further comprise: a means for wirelessly communicating data between said at least two battery powered tag detectors; wherein when one of said at least two battery powered tag detectors detects said at least one tag, a signal is communicated to all of said at least two battery powered tag detectors, said signal causes all of said at least two battery powered tag detectors to sound said alarm. In still yet another embodiment said at least two battery powered tag detectors are magnetic type tag detectors. In another embodiment said at least two battery powered tag detectors are acousto-magnetic type tag detectors. In still another embodiment said at least two battery powered tag detectors are radio frequency type tag detectors. In yet another embodiment said at least two battery powered tag detectors are microwave type tag detectors.

It is to be understood that both the foregoing general description and the following detailed description are merely exemplary of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention; and together with the description serve to explain the principles and operation of the invention.

### BRIEF DESCRIPTION OF THE DRAWINGS

FIG. 1 is a general perspective view of one embodiment of the present invention.

FIG. 2 is a general perspective view of one embodiment of the present invention installed in a yard.

FIG. 3 is a general perspective view of one embodiment of the present invention with an alarm being activated.

FIG. 4 is a general perspective view of one embodiment of the present invention.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

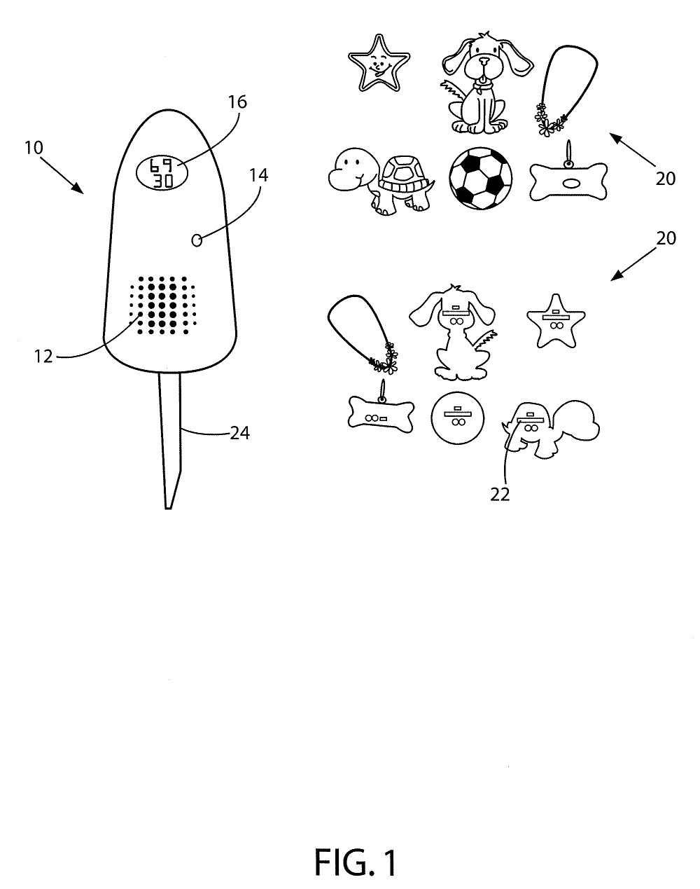

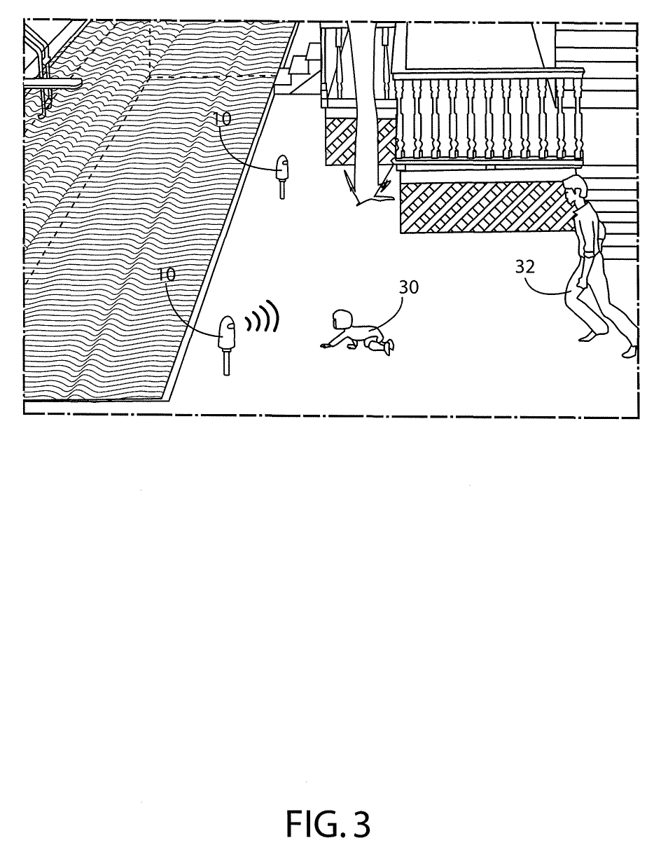

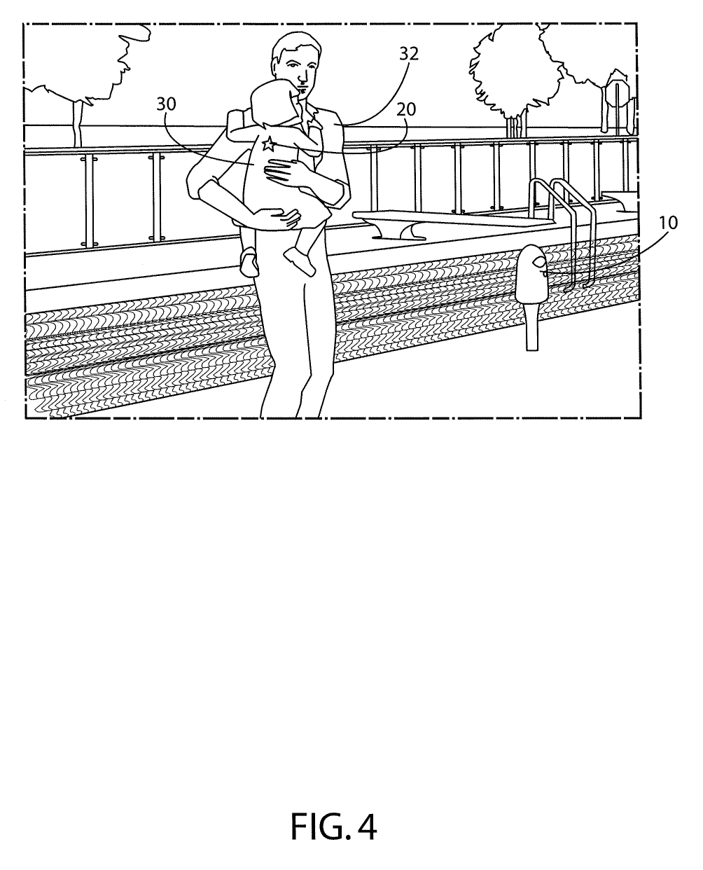

Reference is now made to FIGS. 1-4 which show several views of a preferred embodiment of the present invention. Reference is made more particularly to FIG. 1 which is a general perspective view of one embodiment of the present invention. Motion detector unit 10 comprises speaker 12, indicator light 14, and display 16. Speaker 12 may primarily be used to sound an audible alarm. Indicator light 14 could be used to indicate that the motion detector unit 10 is powered and if batteries are used the batteries are charged to at least a predetermined limit. Display 16 can be used to display a variety of information that may include alarm settings, alarm volume, sensor sensitivity level, sensor type or the like. The motion detector unit 10 also comprises means for detecting, sensing, or monitoring sensors 20. Sensor 20 comprises a sensor or tag 22 that can be detected by motion detector unit 10. Motion detector unit 10 may also have a mounting means 24, which could be in the form of a stake for staking into the ground.

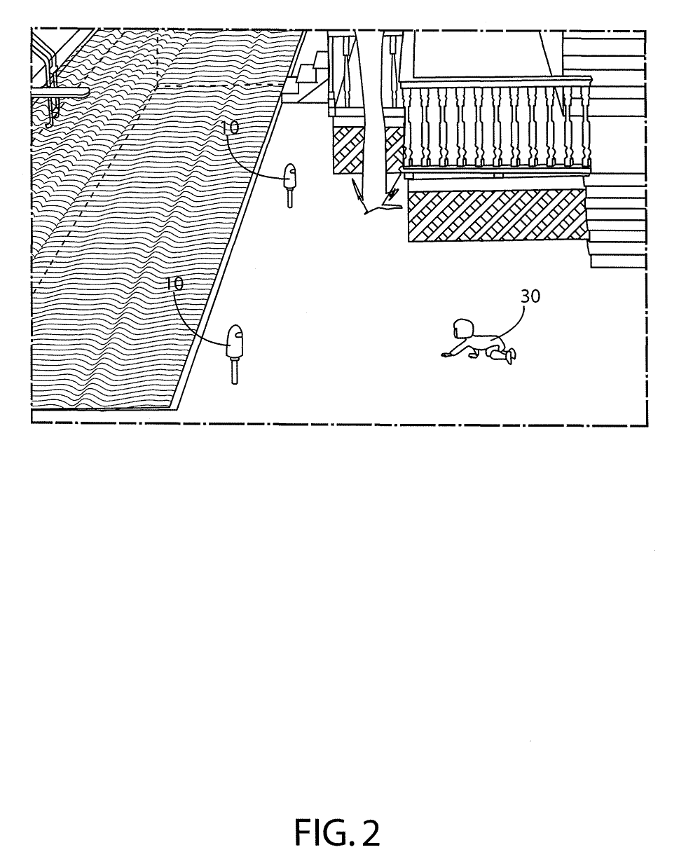

Reference is now made more particularly to FIGS. 2-4 which are general perspective views of one embodiment of the present invention. Motion detector units 10 are setup around hazards or areas the child 30 is to be excluded from. A sensor 20 is affixed to the child's 30 clothing or affixed to the child some other way. When the child 30 moves within the detection range of a motion detector unit 10, the motion detector unit 10 sounds an alarm through speaker 12, thus alerting adult 32. Adult 32 is then able to respond to the alarm in an appropriate manner.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

What is claimed:

1. A method for detecting the presence of a child within a predetermined area comprising the steps of:
a. providing a tag detector,
b. attaching to said child a tag responsive to the electromagnetic radiation generated by said tag detector;
c. said tag receiving said electromagnetic radiation;
d. said tag detector receiving said electromagnetic radiation; and
e. sounding an alarm on said tag detector in response to application of said electromagnetic radiation.

2. The method for detecting the presence of a child as claimed in claim 1, wherein said tag detector is a magnetic type tag detector.

3. The method for detecting the presence of a child as claimed in claim 1, wherein said tag detector is an acousto-magnetic type tag detector.

4. The method for detecting the presence of a child as claimed in claim 1, wherein said tag detector is a radio frequency type tag detector.

5. The method for detecting the presence of a child as claimed in claim 1, wherein said tag detector is a microwave type tag detector.

6. A system for detecting the presence of a child within a predetermined area comprising:
at least two battery powered tag detectors,
at least one tag affixed to a child,
wherein at least one of the at least two battery powered tag detectors sounds an alarm when said at least one tag comes within a predetermined distance from said at least one of the at least two battery powered tag detectors.

7. The system for detecting the presence of a child within a predetermined area of claim 6, wherein said at least two battery powered tag detectors comprise:
at least one stake for affixing to a surface, and
a speaker for audibly sounding said alarm.

8. The system for detecting the presence of a child within a predetermined area of claim 7, wherein said at least two battery powered tag detectors further comprise:
a means for wirelessly communicating data between said
at least two battery powered tag detectors;
wherein when one of said at least two battery powered tag detectors detects said at least one tag, a signal is communicated to all of said at least two battery powered tag detectors, said signal causes all of said at least two battery powered tag detectors to sound said alarm.

9. The system for detecting the presence of a child within a predetermined area of claim 6, wherein said at least two battery powered tag detectors are magnetic type tag detectors.

10. The system for detecting the presence of a child within a predetermined area of claim 6, wherein said at least two battery powered tag detectors are acousto-magnetic type tag detectors.

11. The system for detecting the presence of a child within a predetermined area of claim 6, wherein said at least two battery powered tag detectors are radio frequency type tag detectors.

12. The system for detecting the presence of a child within a predetermined area of claim 6, wherein said at least two battery powered tag detectors are microwave type tag detectors.

13. The system for detecting the presence of a child within a predetermined area of claim 7, wherein said at least two battery powered tag detectors are magnetic type tag detectors.

14. The system for detecting the presence of a child within a predetermined area of claim 7, wherein said at least two battery powered tag detectors are acousto-magnetic type tag detectors.

15. The system for detecting the presence of a child within a predetermined area of claim 7, wherein said at least two battery powered tag detectors are radio frequency type tag detectors.

16. The system for detecting the presence of a child within a predetermined area of claim 7, wherein said at least two battery powered tag detectors are microwave type tag detectors.

17. The system for detecting the presence of a child within a predetermined area of claim 8, wherein said at least two battery powered tag detectors are magnetic type tag detectors.

18. The system for detecting the presence of a child within a predetermined area of claim 8, wherein said at least two battery powered tag detectors are acousto-magnetic type tag detectors.

19. The system for detecting the presence of a child within a predetermined area of claim 8, wherein said at least two battery powered tag detectors are radio frequency type tag detectors.

20. The system for detecting the presence of a child within a predetermined area of claim 8, wherein said at least two battery powered tag detectors are microwave type tag detectors.
